(19) United States
(12) Patent Application Publication
(10) Pub. No.: US 2025/0257533 A1
(43) Pub. Date: Aug. 14, 2025

(54) DURABLE GATE ARM JOINING SYSTEM

(71) Applicants: Jonathan Brinkman, Miami, FL (US); Randy Perez, Miami, FL (US)

(72) Inventors: Jonathan Brinkman, Miami, FL (US); Randy Perez, Miami, FL (US)

(21) Appl. No.: 19/053,377

(22) Filed: Feb. 13, 2025

Related U.S. Application Data
(60) Provisional application No. 63/552,780, filed on Feb. 13, 2024.

(51) Int. Cl. E01F 13/06; F16B 7/18

(52) U.S. Cl. CPC E01F 13/06; F16B 7/182; F16B 7/187

(57) ABSTRACT

A durable gate arm segment joining system forms an assembled gate arm from two or more gate arm segments. Coupling sleeves are inserted and permanently affixed in the ends of the gate arm segments. A connecting rod is used to connect two complementary connecting sleeves with such that external features of the gate arm segments, such as longitudinal channels, are correctly aligned.

### CROSS-REFERENCE TO RELATED APPLICATIONS

This application claims priority to U.S. Provisional Application Ser. No. 63/552,780 filed on Feb. 13, 2024.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

### Field of the Invention

The present invention relates to a system for precision joining of gate arm segments together having cross-section profiles which are not uniformly round. More particularly, the invention relates to manufacturing barrier gate arms in multiple segments having non-continuous radial symmetry connected sequentially by a joining system having enhanced mechanical strength to resist stress and fatigue.

### Description of the Related Art

Barrier gate arms extend across the road from a gate operator's bracket to the far side of the road. Their purpose is to regulate traffic flow through a gated entrance. Their installed lengths typically vary from 8′ to 26′ long. Gate arms are generally constructed from aluminum sheets as thin as practicable to reduce costs and minimize weight of the arm.

Manufacturers of gate arms are constantly seeking new materials and methods of construction that minimize the cost of the gate arm. It is also desirable to form gate arms as lightweight as possible. This minimizes the amount of energy required to raise and lower the gate arms. Unfortunately, because gate arms are long and thin, they are constantly exposed to substantial bending forces due to the constant raising and lowering of them to allow vehicles to pass by. Currently, the strongest most durable and most lightweight manner of manufacturing gate arms is to fabricate them from a single elongate piece of aluminum. However, when sold as a solid continuous pipe, the barrier arms are difficult to transport across the country by LTL trucks, and they are difficult to transport to job sites by gate company trucks. They are also cumbersome and bulky to manage while at a job site doing a barrier arm installation. When damaged, the entire barrier arm must be replaced, which is a costly repair.

It is substantially cheaper and more convenient to ship or transport shorter objects. It is therefore desirable to be able to ship barrier gate arms in smaller segments. However, it is difficult to connect shorter gate arm segments to form a single longer gate arm in a manner that is long-lasting and durable. The joint between the two segments is constantly subjected to substantial forces caused by the weight of the arm as it is constantly raised and lowered. Nonetheless, there are currently a number of different methods of connecting gate arm segments. Some involve attempts to adapt existing pipe-join mechanisms, such as techniques used from plumbing, for use with gate arms.

Screw Together Gate Arm Joints. This system facilitates pipe connections in various ways that are not new or unique. A typical method is for one side of the Pipe-Join to have a “male” side that has exterior thread and a “female” side that has interior thread. The two sides are screwed together, forming a tight bond. This is common in plumbing applications. However, these systems are not suitable for gate arms that have longitudinal channels that must be properly aligned. That works fine for uniform circular pipes, but not for extrusions with distinct channels. Simple threaded joining systems allow for two gate arm segments to abut against one another, but do not usually result in longitudinal structures on separate segments, such as an external LED light channel or bumper attachment groove, to align properly.

Joining Systems for Gate Arms that are Not Uniformly Round. The situation is much more complicated when the two gate arm segments are not uniformly round. An example is a gate barrier arm that has LED (or other) retention tracks embedded in or on the arm (either internal or external to the general outer diameter of the gate arm). These gate arm segments must be joined such that the LED tracks (or other affixed appendages) align perfectly on both sides of the gate arm. The gate arm connection must also be tight so that the gap between the gate arm segments at the joint is minimized. If the appendages (like LED tracks) are on the interior of the pipes, the complexity is heightened further since the typical male/female screw together methodology described above cannot be used.

Internal Shell Gate Arm Joining Systems with Standards Screws and/or Rivets. A common technique for joining gate arms is to insert a smaller-diameter shell into both sides of the complex profile pipes and affix that shell to the gate arm segments. The gate arm segments are then attached to the smaller-diameter shell at a number of attachment points. The attachment points could use screws, rivets, or other standard hardware. In general, that is a satisfactory method for attaching pipes that do not endure high stresses at the pipe-join location. For example, water pipes that are buried in the ground do not generally bend at the Pipe-Join location, so the Pipe-Join attachment components (like rivets or rivet nuts) would not endure high stresses. A manufacturing challenge with this technique involves extrusion tolerances of the pipes and the inner join shell. Since wall-thickness of extruded parts will increase over time as the extruder die erodes, tightly-fitting parts cannot be used or the inner shell will not fit into the outer casing. They are consequently manufactured to be fairly loose-fit and to provide a connective solution, not to create a true seal.

A more important consequence of a loosely-fit pipe-join involves torsional and flexural (“bending”) stress at the Pipe-Join, especially when the connected pipes are not supported by the ground or a truss system to remove those stresses. An example of this situation is a gate barrier arm which is affixed to a barrier operator machine on one side of a vehicular street. Since only one side is supported, the remainder of the barrier arm is either hanging in the air (when horizontal) or sticking straight up in the air (when vertical). It also endures stresses along the entire barrier arm when elevating and descending. Bending stress analysis is crucial for ensuring that the gate arm segment joints can withstand the loads without failing due to excessive bending, which could lead to deformation or fracture. Using a standard shell+screws technique to connect these pipe sections would transfer much of the high flexural stresses to the attachment points, which are the weakest link in the Pipe Join. If hardened screws or rivets are used, the stresses will be transferred to the female receiver of those screws, or to the internal pipe walls where the screws are seated. The stresses are focused on small metal connecting hardware. Over time, those poorly-distributed stresses will cause the connecting hardware to deform, or the (hardened) hardware may deform the pipes. These stresses are cumulative since the metal does not heal after enduring stress events, so eventually the Pipe-Join section will catastrophically fail, causing the pipes to become “un-joined”. This sudden disconnection could cause terrible damage to the connected operator equipment, to nearby vehicles or equipment, and potentially injurious damage to people or pets. In summary, connection methods that use hardware create additional points of potential failure for the entire device. Deformation and failure of these small components can greatly increase the stresses on other components, leading to a cascade system failure.

Another problem with pipe-join technology used to-date involves the cost the assembly hardware. Best practice with exterior applications is to use stainless steel or aluminum components to avoid oxidation and dissimilar-metal corrosion, which can cause appearance degradation and even component failure. Stainless steel components are generally an expensive option. Aluminum hardware (like rivets) lacks sufficient strength for the pipe-join application, so larger-scale aluminum hardware is required and is costly.

Another problem with Pipe-Join technology used to-date involves the weight of that hardware. Using screws and threaded inserts adds significant weight to the Pipe-Join location, which can impact overall pipe weight significantly, especially on a “tilt-up” gate where weight stresses scale up exponentially depending on the distance from the pivot location.

Another problem with Pipe-Join technology used to-date involves assembly. The installing technician must merge the pipes with the internal support component using multiple connectors like screws and rivets. This assembly process can take excessive time for a field technician, and since it uses many small parts it is likely that parts could get lost during transport to a job site. The technician might even need specialized tools to complete the assembly (like a rivet gun). These inconveniences will probably negatively impact the technician's attitude and opinion regarding using the involved products in the future.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide a precision pipe-join system with improved strength, durability and distribution of stresses. It is also desirable to provide a pipe-join system that is easy to install and precisely aligns sections of the pipe segments which have non-continuous radial symmetry.

### BRIEF SUMMARY OF THE INVENTION

Disclosed is a new method to connect two non-round gate arm segments together that ensures a minimal gap between gate arm segments, excellent stress distribution, and a perfectly precise final alignment for the two gate arm segments. The system of the invention provides several benefits, including distribution of the torsional and flexural stresses evenly to the walls of two joined gate arm segments so that no particular area endures special stresses, minimizes the parts required, reduced weight, reduced cost, minimizes potential points of failure, rapid field-assembly, and reduced manufacturing time and cost for the component parts.

The durable gate arm segment joining system of the invention is well suited for barrier gate arms commonly used to control vehicle access points. In one embodiment, the system of the invention utilizes 4′ aluminum gate arm segments which are joined together. An exemplary 12′ barrier arm has three 4′ gate arm segments connected by two joining systems as described herein. A 16′ barrier arm has four gate arm segments connected by three joining systems of the invention. Gate arm segments may be more or less than 4′ depending on the type of gate arm being formed, the gate arm's intended function and other factors recognized by those skilled in the art. Gate arm segments may optionally have non-uniform lengths.

The gate arm segments are joined together by the installing technician at the final job site. By reducing the length of the barrier gate arm from, for example, one 12′ gate arm segments to three 4′ gate arm segments, the inconveniences and high costs of overlength transport are eliminated. In addition, any of the gate arm segments can be easily replaced individually in case of damage, thus reducing repair cost and inconvenience. Smaller pipe segments are easier to install, requiring less effort by the installers, and are easier to store both in warehouses and/or at a job site.

A durable gate arm segment joining system comprises a first gate arm segment having a cross-sectional shape that is not uniformly round. A first coupling sleeve has a central threaded bore open at a distal end permanently and is continuously affixed to an inside wall of the first gate arm segment. A second gate arm segment has a cross-sectional shape congruent to the cross-sectional shape of the first gate arm segment. A second coupling sleeve has a central threaded bore open at a proximal end permanently and is continuously affixed to an inside wall of the second gate arm segment. A threaded connecting rod is configured such that when it is fully threadedly engaged with the first coupling sleeve and the second coupling sleeve the first and second gate arm segments form an assembled gate arm such that their cross-sectional shapes align to provide continuous longitudinal symmetry along the assembled gate arm.

The durable gate arm segment joining system may include the first and second coupling sleeves having continuous external walls that each form a continuous connection with the internal walls of the first and second gate arm segments. The first and second segments exterior longitudinal channels that align when the first and second segments form an assembled gate arm. The first gate arm segment is flush with an end of the first connecting sleeve and an end of the second gate arm segment is flush with an end of the second connecting sleeve.

In one embodiment, A durable gate arm segment joining system comprises a first gate arm segment having a first coupling sleeve affixed to an inside wall of the distal end of the first segment. A threaded connecting rod is partially inserted into a threaded central bore in the first coupling sleeve and has a region partially extending distally from the first coupling sleeve. A second gate arm segment has a second coupling sleeve affixed to an inside wall of its proximal end. The region of the connecting rod extending distally from the first coupling sleeve is screwed into the threaded central bore in the second coupling sleeve.

It is therefore an object of the present invention to provide a precision pipe-join system to reduce costs and facilitate simpler transport, assembly, and storage. It is another object of the invention to provide a precision pipe-join system for assembling segments of pipe having non-continuous radial symmetry and which require precise alignment of features or components arranged longitudinally down the joined pipe.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an exploded perspective view of a precision pipe join system in accordance with principles of the invention;

FIG. 2 is an exploded side view of a precision pipe join system in accordance with principles of the invention;

FIG. 3 is a front plan view of a pipe segment of a precision pipe join system in accordance with the principles of the invention;

FIG. 4 is a side elevation view of a pipe segment of a precision pipe join system in accordance with principles of the invention;

FIG. 5 is a front plan view of a coupling sleeve of a precision pipe join system in accordance with principles of the invention;

FIG. 6 is a side elevation view of a coupling sleeve of a precision pipe join system in accordance with principles of the invention;

FIG. 7 is a front plan view of a connecting rod affixed to a coupling sleeve of a precision pipe join system in accordance with principles of the invention;

FIG. 8 is a side elevation view of a connecting rod affixed to a coupling sleeve of a precision pipe join system in accordance with principles of the invention;

FIG. 9 is a front plan view of an alternative embodiment of a connecting rod of a precision pipe join system in accordance with principles of the invention;

FIG. 10 is a side elevation view of an alternative embodiment of a connecting rod of a precision pipe join system in accordance principles of the invention;

FIG. 11 is a cross-sectional view of an alternative embodiment of a durable gate arm joining system in accordance with the principles of the invention;

FIG. 12 is a barrier gate having a barrier gate arm assembled from gate arm segments in accordance with the principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein. Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

Unless otherwise indicated, all numbers expressing quantities of ingredients, dimensions, reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise. When describing gate arm cross-sections, “not uniformly round” and “non-continuous radial symmetry” are substantially synonymous and refer to gate arm and gate arm segments that may be almost perfectly circular except for a single added structure such as a longitudinal channel or protrusion, in addition to gate arm and gate arm segments with discrete symmetry such as having a polygonal cross section, e.g. square and hexagonal, as well as other radially asymmetric deformities, such as being oval. The designation of ends as being distal or proximal is generally interchangeable as the terms are intended to be relative to each other. Thus, stating that an identified distal end abuts an identified proximal end has the same meaning if the terms “distal” and “proximal” are interchanged.

Various embodiments of the disclosure could also include permutations of the various elements recited in the claims as if each dependent claim was a multiple dependent claim incorporating the limitations of each of the preceding dependent claims as well as the independent claims. That is, the combinations of the various components of the invention are not limited to those combinations expressly shown in the Figures. Unless expressly stated otherwise, components described in one embodiment may be interchanged with components of the same name found in other embodiments. Such permutations are expressly within the scope of this disclosure. Further, the various components of the invention are not necessarily drawn to scale relative to each other. Components may be longer or shorter than shown in the drawings. The various components of the invention are drawn to illustrate how they interact with each other.

Our design uses shrink-fit technology to connect gate arm segments together without welding, soldering or using secondary fasteners in a manner that uniformly distributes the stresses placed on the joint. This creates a durable joint that will not loosen over time due. Coupling sleeves that match the internal shape of the gate arm segment are provided with central, threaded bores. These coupling sleeves are shrink fit into the ends of gate arm segments. Essentially, one pipe has a slightly larger inner diameter than the other pipe's outer diameter. At room temperature the pipes would not slide together because the size difference is too small to connect them. However, when the larger side is super-heated and the smaller side is super-cooled, the hot side expands and the cold side contracts. The cold side is inserted into the hot side and they merge together permanently as their temperatures normalize.

The threaded connecting rod is then screwed into the bores of complimentary coupling sleeves to join two gate arm segments. The connecting rods and the central bores in the coupling sleeves are precision milled to create properly “phased” threads so that the final rotation angle is locked in to assure final “clocking” of the orientation of the two coupling sleeves and the connecting rod.

The gate arm segment joining technology disclosed herein utilizes two primary components to connect gate arm segments. Coupling sleeves are inserted into and permanently and continuously secured to the ends of a pipe segment. A connecting rod is utilized to affix the two coupling sleeves together.

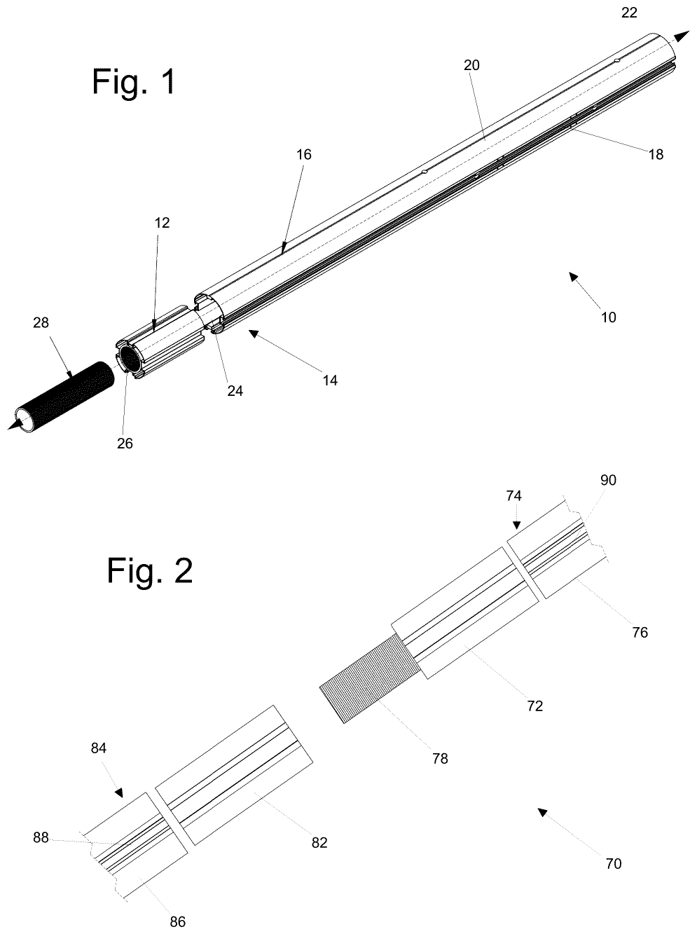

FIGS. 1 shows the primary components of a durable gate arm segment joining system 10 in accordance with principles of the invention. The coupling sleeve 12 is sized and configured to fit within the end 14 of a gate arm segment 16. The gate arm segment 16 has one or more external channels 18 extending along its outer wall 20 in a longitudinal direction 22. Thus, the pipe segment has discrete, not continuous, radial symmetry, i.e. it is not uniformly round. The coupling sleeve 12 is configured to have a continuous outer wall complimentary to the inner wall 24 of the gate arm segment 16 such that it forms a tight fit with the inner wall 24. The coupling sleeve 12 includes a threaded central bore 26. A connecting rod 28 is sized to fit within the central bore 26. Connecting rod 28 is solid to maximize the strength of the joining system of the invention.

The coupling sleeve 12 is affixed to the inside of the end 14 of the gate arm segment 16 such that the ends of both the gate arm segment and coupling sleeve are flush. The sleeve 12 and segment 16 are secured to one another using a shrink fitting technique prior to shipping. Those skilled in the art will appreciate the assembly shows in the figures may be utilized on either or both ends of a gate arm segment which is to be connected to one or more segments to form a complete gate arm.

Shrink fitting is a process for securely attaching to components without the use of bolts, welding, adhesives, threading or other mechanical fastening systems. Using the shrink fitting process, the gate arm segments are manufactured to have an internal diameter substantially equal to the coupling sleeve's external diameter. The external surface of the coupling sleeve is preferably continuous, as is the internal wall of the gate arm segment. The coupling sleeve cannot slide into the gate arm segment when both are at room temperature. To affix the two components, the gate arm segment is super-heated and the coupling sleeve is super-cooled by, for example, using liquid nitrogen. The ultra-cold Coupling Sleeve is then completely inserted into the outer section's super-hot terminal end, using jigs to ensure precise depth positioning. Generally, it is desirable but not required for the ends of the gate arm segment and the coupling sleeve to be flush. When the cold inner surface warms and the hot outer surface cools, they are bonded together permanently and equally across the entire Coupling Sleeve. Thus, the stresses are distributed from the Coupling Sleeve to the inner walls of the gate arm segments uniformly.

Both the threaded connecting rod 28 and the coupling sleeve 12 may be thread-tapped by a high-precision CNC lathe to have extremely precise thread positioning. The central bores of 26 of the coupling sleeve's 12 are thereby provided with threading that align smoothly when the two coupling sleeves 12 are abut each other in a congruent orientation. That is, when the cross-sectional shapes of the couple sleeve's are aligned to form continuous longitudinal symmetry, the threading of their bores also align form a continuous threading. This ensures that when two gate arm segments are attached using the connecting rod, any external channels or other structural features intended to be longitudinally continuous will align when the coupling sleeves are both fully engaged with a connecting rod such that the gate arm segments are flush against each other. Because of this precise alignment, gate arm components that engage the longitudinal features may provide sufficient resistance to unscrewing of the connecting rod.

For example, gate arm may include one or more external channels for housing LED light strips. The coupling sleeves are precision milled such that the threading of their internal bores align when the coupling sleeves are properly aligned. Because the coupling sleeves are shrink fitted flush with the end of the gate arm segment, the LED light strip channels will align when two gate arm segments are fully threadedly engaged with a connecting rod. Once an LED light strip, even a relatively light one, is inserted into the external channel, its presence is sufficient to prevent the coupling sleeves to unscrew from the connecting rod. In addition, when a gate arm is in the down, or horizontal position, the force of gravity acting on the joining system prevents rotation and unwinding of the connecting rod.

Threads on the connecting rod which enter the coupling sleeve at a precise starting spot so that when fully screwed-in, i.e. “seated,” the gate arm segments align precisely. This ensures that the LED (or other) tracks, channels, and other longitudinal features of the assembled pipe are precisely aligned. Misalignment would prevent installers from inserting the LED strips, bottom edges, rubber bumpers, or other long objects that extend across the entire merged pipe. Those skilled in the art will appreciate that this system utilizes threads on the connecting rod and coupling sleeve that are tapped with extreme precision. This system also inserts the coupling sleeve into the Pipe with extreme depth precision. In this embodiment, the gate arm segments are approximately four feet long, and the connecting rod is approximately six inches long. The connecting sleeves have a threaded central bores that are three inches each. The bores may include a floor three inches in to match the length of the connecting rod. Typically, three inches is sufficient depth for a four foot long aluminum gate arm segment, and keeps the overall weight sufficiently low to minimize stress on the assembled gate arm.

FIG. 2 shows an alternative embodiment of the invention 70. In this embodiment, the end 74 of the gate arm segment 76 has a “male” coupling sleeve 72 having a threaded connecting rod 78 extending from the coupling sleeve 72. Opposite to the “male” coupling sleeve 72 is a “female” coupling sleeve 82 that has a threaded central bore complementary to the threaded connecting rod 78. The female coupling sleeve 82 is affixed inside proximal end 84 of a second gate arm segment 86 which has one or more longitudinal channels 88. The channels 88 of segment 86 align with channels 90 of the first pipe segment 76 when the male and female coupling sleeves 72 and 82 are fully threadedly engaged. This is because the threading of the two coupling sleeves has been precisely aligned as explained above. The male coupling sleeve 72 may be formed by shrink fit. A coupling sleeve 12 as shown in FIG. 1 is heated while a connecting rod 28, also shown in FIG. 1, is super cooled. The two components are then combined and become permanently affixed to form the male coupling sleeve 72. Coupling sleeve 82 is therefore substantially the same as coupling sleeve 12. Generally, it may be preferred to not affix the connecting rod 28 to one of the coupling sleeves, especially if the gate arm segments have a maximum desired length. If it is desirable to form a male coupling sleeve, the portion of the connecting rod inserted into a coupling sleeve may be smooth rather than threaded. Similarly, a central bore into which a connecting rod is shrink fit need not be threaded.

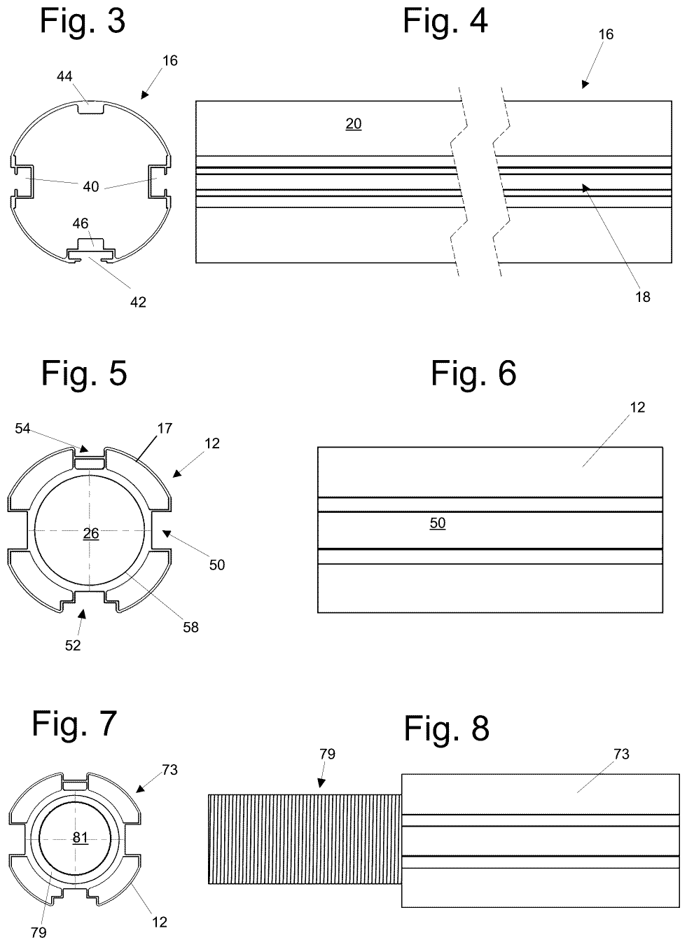

FIGS. 3 and 4 show the gate arm segment 16. In this embodiment, the first pipe segment 16 is part of a barrier gate that is raised and lowered to control access of vehicles into a parking lot, parking garage, private property, community, neighborhood or the like. Those skilled in the art will appreciate that barrier gate arms typically include safety features and other components extending longitudinally along the length of the arm. LED light systems have become quite common for improving visibility of a gate arm. Elastomeric bumpers may also be included along the bottom of the gate arm to prevent damage when the arm inadvertently strikes a vehicle. These longitudinal features, such as channels, may also be used to extend electrical wires and other devices for actuating or controlling additional lighting or other components along the length of the gate arm. Thus, gate arm segment 16 includes three external channels 18, which include two side channels 40 and a bottom channel 42. Gate arm segment 16 also includes an internal upper longitudinal rib 44 and a lower longitudinal rib 46 integrated forming part of the floor of the lower channel 42. These ribs provide additional strength of the pipe segment 16. There are many applications and uses for gate arm segments that do not require such longitudinal features and thus accommodate threading or other connection mechanisms directly on the internal wall of the pipe itself. However, when gate arm segments do not have continuous radial symmetry, directly connecting segments using threaded components is generally considered not feasible prior to the present invention. Usually one or more metal plates, or even shells smaller then the outer wall of the gate arm segment, would be inserted into two adjacent gate arm segments and connected with bolts or rivets.

FIGS. 5 and 6 show the connecting sleeve 16 of the invention in more detail. The continuous external wall 17 of the connecting sleeve 12 matches the internal wall 24 of the gate arm 16. External wall 17 of the sleeve 12 includes external longitudinal side channels 50 corresponding to the side channels 40 of the pipe segment 16. Because the external wall 17 is continuous, it is able to continuously impinge or lie flush against the internal wall of a gate arm segment, maximizing the surface area of connection for the gate arm segment joining system of the invention. Sleeve 16 also includes a lower channel 52 and upper channel 54 corresponding to ribs 42 and 44 on the segment 16, respectively. The connecting sleeve may be completely solid, or may include one or more cavities to decrease weight, so long as sufficient ribbing or other structure, e.g. a honeycomb support structure, is included to provide adequate strength. The inner wall 58 of the sleeve 12 defines the threaded central bore 26. Optionally, central bore may be smooth and configured to be permanently attached to a nonthreaded portion of a connecting rod using the shrink fit process, as explained in relation to FIG. 2 above.

FIGS. 7 and 8 show an alternative “male” connecting sleeve 73 for use as shown in of FIG. 2. The connecting rod 79 in this embodiment is hollow, forming a smooth central bore 81 minimize weight of the joining system. The threaded connecting rod 79 extends out a precise distance and is precisely threaded to ensure that when a female connecting sleeve is screwed onto it, all of the channels in the pipe segments correctly align.

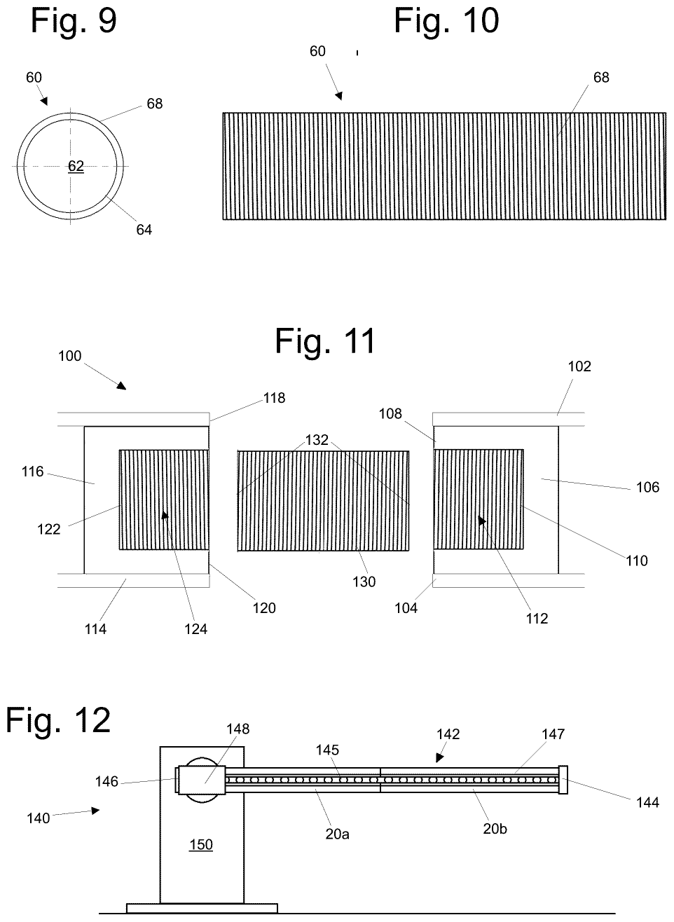

FIGS. 9 and 10 show an alternative embodiment of a connecting rod 60. Connecting rod 60 is hollow, with a central bore 62 defined by an inner wall 64. As explained above, this reduces the overall weight of the joining system. In this embodiment, the entire cylindrical outer surface 68 of the connecting rod 60 is threaded. It may nonetheless still be affixed to an internal smoothbore of a connecting sleeve using the shrink fit method or alternatively, both coupling sleeves may be internally threaded along their borders. So long as both connecting sleeves are precisely thread tapped and correctly positioned within their respective gate arm segments, the connecting rods may be used to precisely aligned longitudinal elements such as the channel shown above.

Those skilled in the art will readily identify several distinctions in benefits between the prior arts in the present invention. The present invention does not require bolts or rivets, making it simpler, lighter, easier to install, less expensive and more reliable than connecting mechanisms having many separate components. All of the components may be manufactured from the same type of material, thereby obviating any galvanic corrosion concerns and simplifying sourcing of the raw materials. The present invention is also durable and will suffer less degradation than other connecting mechanisms. The installation process for gate arm segments formed by pipe segments connected according to the present invention requires less time and less skill than many other techniques, making it more foolproof. Assembly complexity is greatly reduced which makes installations and repairs much simpler for untrained or physically-limited repair personnel. The shrink-fit Coupling Sleeve of the present invention tightly engages an irregular outer profile, making it highly resistant to torque stresses.

Because the present invention incorporates a shrink-fit gate arm joining system, combined with precisely milled and aligned threading, the gate arm segment connections are substantially water resistant and prevent exterior water intrusion. This water resistance may optionally be made more effective by adding O-rings or gaskets to improve the seal between gate arm segments. Because the present invention utilizes shorter gate arm segments in lieu of fully formed gate arm segments, is more easily stored and transported. In addition, the connections of the present invention actually strengthen the complete overall pipe, and allows it to absorb vibration better than a continuous pipe design. This further reduces the chance that the couplers would loosen. The present invention also dampens vibrations, preventing harmonic resonance of vibrations through the pipe.

Those skilled in the art will appreciate that the ability to precisely linearly align pipe segments when joining them together can also apply to pipe systems that must be coplanar. Many curved pipe systems must be confined to a wall, floor, ceiling, or other relatively narrow, substantially planar location. Curved pipes may have the coupling sleeves and connector rods described above incorporated into their ends and arranged such that the curved pipe segments lie in the same plane when joined.

FIG. 11 shows another alternative embodiment of a gate arm segment joining system 100 in accordance with the principles of the invention. A first gate arm segment 102 has an internal coupling sleeve 106 affixed to it using a shrink fit technique as described above. The end 104 of the gate arm segment 102 is substantially flush with the end 108 of the coupling sleeve 106. The coupling sleeve 106 also includes a floor 110 where it's threaded central bore 112 ends. Similarly, a second gate arm segments 114 has an internal coupling sleeve 116, also affixed using a shrink fit technique. The end 118 of the arm segments 114 is substantially flush with the end 120 of the coupling sleeve 116. The coupling sleeve 116 also has a floor 122 where it's threaded central bore 124 ends. The central bores 112 and 124 are precision milled such that there threading aligns when the asymmetric structural features of the gate arm segments 102 and 114 are longitudinally aligned. A connecting rod 130 is sized such that it ends 132 abuts the floors 110 and 122 of the coupling sleeves 106 and 116, respectively. Because the ends 132 of the connecting rod 130 abuts the floors of the coupling sleeves, the joining system is further stabilized and provides for even more even distribution of forces among all the various components.

The overall length of the male connector in this embodiment is double the length of the thread depth in the female coupling sleeve. The female coupling sleeves are precision-tapped to 50% of the length of the male connector. The coupling sleeve's thread starts and stops at the location where the male connector's thread starts. Dead-center on top is usually the alignment reference. The coupling sleeves are inserted into the segment until the end terminus of the sleeve is flush with the end of the segment. There is no substantial gap where the sleeve and segment align. This ensures that the distance that the male connector must travel is equal to the depth of the coupling sleeve. This ensures the final threads terminate perfectly.

FIG. 12 shows a barrier gate arm traffic control system 140 that includes two gate arm segments 20 as shown in FIG. 1. The a proximal gate arm segment 20a and a distal gate arm segment 20b are connected using connecting sleeves 12 and a connecting rod 28, as shown in FIG. 1, to form a complete assembled barrier gate arm 142 with an aligned external channel 147. An LED light strip 145 extends through an external channel 147 of the complete barrier gate arm 142. The gate arm 142 is capped at one end 144 and its other end 146 is inserted into a bracket 148. The bracket 148 is affixed to the control system 150 so that it may be rotated into an up, vertical, and down, horizontal, positions. The two segments 20 have been screwed onto the connecting Rod 28 such that the segments 20 abuts against each other and the external channel 147 has aligned. Those skilled in the art will appreciate that such a gate arm joining is constantly exposed to a bending stress. Because the force on the proximal segment 20a is transferred over the entire surface of both of the internal connecting sleeves, the force is evenly distributed. As a result, the joint remains rigid. If one of the segments is damaged by a collision or other incident, it can be replaced without needing to replace the entire gate arm.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A durable gate arm segment joining system comprising:
a first gate arm segment having a cross-sectional shape that is not uniformly round;
a first coupling sleeve having a central threaded bore open at a distal end permanently and continuously affixed to an inside wall of the first gate arm segment;
a second gate arm segment having a cross-sectional shape congruent to the cross-sectional shape of the first gate arm segment;
a second coupling sleeve having a central threaded bore open at a proximal end permanently and continuously affixed to an inside wall of the second gate arm segment;
a threaded connecting rod configured such that when it is fully threadedly engaged with the first coupling sleeve and the second coupling sleeve the first and second gate arm segments form an assembled gate arm such that their cross-sectional shapes align to provide continuous longitudinal symmetry along the assembled gate arm.

2. The durable gate arm segment joining system of claim 1 wherein the first and second coupling sleeves have continuous external walls that each form a continuous connection with the internal walls of the first and second gate arm segments.

3. The durable gate arm segment joining system of claim 2 wherein the first and second segments exterior longitudinal channels that align when the first and second segments form an assembled gate arm.

4. The durable gate arm segment joining system of claim 3 wherein an end of the first gate arm segment is flush with an end of the first connecting sleeve and an end of the second gate arm segment is flush with an end of the second connecting sleeve.
